(19) United States
(12) Patent Application Publication
(10) Pub. No.: US 2022/0004264 A1
(43) Pub. Date: Jan. 6, 2022

(54) INFORMATION PROCESSING APPARATUS, INFORMATION PROCESSING METHOD AND CONTROL SYSTEM

(71) Applicant: Toyota Jidosha Kabushiki Kaisha, Toyota-shi (JP)

(72) Inventors: Yurika Tanaka, Yokosuka-shi (JP); Yu Nagata, Chofu-shi (JP); Kenichi Yamada, Nisshin-shi (JP); Ryuichi Kamaga, Nisshin-shi (JP); Ai Miyata, Okazaki-shi (JP); Satoshi Komamine, Nagoya-shi (JP); Shintaro Matsutani, Kariya-shi (JP)

(21) Appl. No.: 17/359,850

(22) Filed: Jun. 28, 2021

(30) Foreign Application Priority Data
Jul. 1, 2020 (JP) 2020-114395

(51) Int. Cl. G06F 3/01; G06K 9/00

(52) U.S. Cl. CPC G06F 3/017; G06K 9/00335

(57) ABSTRACT

The present disclosure provides a technique for performing apparatus control by gestures. An information processing apparatus acquires sensor data from one or more sensors for detecting gestures performed by a user, the sensors being installed indoors, and detects a gesture of a first type specifying an apparatus which is an operation target among a plurality of apparatuses and a gesture of a second type specifying an operation to be performed for the apparatus, based on the sensor data. The information processing apparatus executes the specified operation for the specified apparatus when both of the gesture of the first type and the gesture of the second type are detected.

### CROSS REFERENCE TO THE RELATED APPLICATION

This application claims the benefit of Japanese Patent Application No. 2020-114395, filed on Jul. 1, 2020, which is hereby incorporated by reference herein in its entirety.

### BACKGROUND

### Technical Field

The present disclosure relates to a technique for supporting an operation of an apparatus.

### Description of the Related Art

Technology for performing control of electronic equipment and home electrical appliances without using operation means such as a remote controller has spread. For example, in Patent Literature 1, a system enabling operation of a television set by voice recognition is disclosed.

Patent Literature 1: Japanese Patent Laid-Open No. 2020-010387

Patent Literature 2: Japanese Patent Laid-Open No. 2017-204859

### SUMMARY

In the case of using a voice to operate an apparatus, it is required to utter the content of a command each time. Further, there is a problem that accuracy drops under a noisy environment.

An object of the present disclosure is to provide a technique for performing apparatus control by gestures.

A first aspect of the present disclosure is an information processing apparatus including a controller, the controller being configured to execute: acquiring sensor data from one or more sensors for detecting gestures performed by a user, the sensors being installed indoors; detecting a gesture of a first type specifying an apparatus which is an operation target among a plurality of apparatuses and a gesture of a second type specifying an operation to be performed for the apparatus, based on the sensor data; and executing the specified operation for the specified apparatus when both of the gesture of the first type and the gesture of the second type are detected.

A second aspect of the present disclosure is an information processing method to be performed by a computer, the information processing method including: acquiring sensor data from one or more sensors for detecting gestures performed by a user, the sensors being installed indoors; detecting a gesture of a first type specifying an apparatus which is an operation target among a plurality of apparatuses and a gesture of a second type specifying an operation to be performed for the apparatus, based on the sensor data; and executing the specified operation for the specified apparatus when both of the gesture of the first type and the gesture of the second type are detected.

A third aspect of the present disclosure is a control system including: one or more sensors for detecting gestures performed by a user, the sensors being installed indoors; and an information processing apparatus configured to execute: acquiring sensor data from the sensors; detecting a gesture of a first type specifying an apparatus which is an operation target among a plurality of apparatuses and a gesture of a second type specifying an operation to be performed for the apparatus, based on the sensor data; and executing the specified operation for the specified apparatus when both of the gesture of the first type and the gesture of the second type are detected.

As another aspect, a program for causing a computer to execute the information processing method executed by the information processing apparatus described above or a computer-readable storage medium that non-temporarily stores the program is given.

According to the present disclosure, it is possible to provide a technique for performing apparatus control by gestures.

### BRIEF DESCRIPTION OF THE DRAWINGS

FIG. 1 is a diagram illustrating an outline of a control system;

FIG. 2 is a diagram illustrating components of the control system in more detail;

FIG. 3 is a diagram illustrating a plurality of sensors and apparatuses installed indoors;

FIG. 4A illustrates an example of first data stored in a storage;

FIG. 4B illustrates an example of second data stored in a storage;

FIG. 5 illustrates an example of apparatus data stored in the storage;

FIG. 6 is a flowchart of a process executed by a controller of an information processing apparatus;

FIG. 7 illustrates an example of the first data used in a second embodiment;

FIG. 8 is a diagram illustrating positional relationships between a user and apparatuses indoors; and

FIG. 9 illustrates an example of the first data used in a third embodiment.

### DESCRIPTION OF THE EMBODIMENTS

There are apparatuses (electrical appliances, computers and the like) that are mounted with cameras and can be operated by gestures. However, since there are various apparatuses indoors, a user has to learn all commands that these apparatuses can accept. Further, it is necessary to move into the field of view of each camera to perform an operation.

In order to solve this problem, in an information processing apparatus according to the present embodiment, a controller may execute: acquiring sensor data from one or more sensors for detecting gestures performed by a user, the sensors being installed indoors; detecting a gesture of a first type specifying an apparatus which is an operation target among a plurality of apparatuses and a gesture of a second type specifying an operation to be performed for the apparatus, based on the sensor data; and executing the specified operation for the specified apparatus when both of the gesture of the first type and the gesture of the second type are detected.

By acquiring gestures by one or more sensors installed indoors, it is possible to remove the restriction that, for each apparatus, the camera's field of view is different. In one example, the sensors are installed at positions where the activity range of the user can be captured (for example, each indoor room).

Further, by separately detecting a gesture of the first type and a gesture of the second type and executing an operation for an apparatus when both of the gestures are obtained, it becomes possible for the user to perform operations for a plurality of apparatuses more intuitively.

The gesture of the first type is a gesture for specifying an apparatus which is an operation target. The gesture of the first type may be a gesture that is different for each apparatus. Further, the gesture of the first type may be such a gesture that the gesture itself is the same (for example, a pointing gesture) but a destination pointed to is different for each apparatus.

The gesture of the second type is a gesture for specifying an operation for the apparatus. The gesture of the second type may be a gesture common to a plurality of apparatuses. For example, a gesture of moving a palm of a hand upward may be assigned to operations of “turning up the volume (television set)” and “raising the temperature (air conditioner)” and the like.

The information processing apparatus may further include a storage configured to store first data for detecting one or more gestures belonging to the first type and second data for detecting one or more gestures belonging to the second type.

The first data and the second data can be, for example, feature value data for recognizing gestures.

Further, the first data may be data in which the plurality of gestures belonging to the first type are associated with the plurality of apparatuses, respectively; and the controller may identify the apparatus specified by the user based on the gesture belonging to the first type.

Gestures and particular apparatuses can be linked by the first data.

When a different gesture is defined for each apparatus, the linking may be performed by associating particular gestures with particular apparatuses. Further, when a direction pointed to is different for each apparatus though a gesture itself is the same, the linking may be performed by associating directions shown by the gesture with particular apparatuses.

Further, the first data may be data in which combinations of the plurality of gestures belonging to the first type and sensors that have detected the gestures are associated with the plurality of apparatuses, respectively; and the controller may identify the apparatus specified by the user, based on the gesture belonging to the first type and a sensor that has detected the gesture.

Thus, it is also possible to identify an apparatus by a combination of a gesture and a sensor that has detected the gesture. Thereby, for example, in a case where sensors are installed in a plurality of rooms, the same gesture can be assigned to apparatuses of the same kind (for example, a television set installed in a living room, a television set installed in a private room and the like).

Further, when detecting the gesture belonging to the first type, the controller may identify a place shown by the gesture.

For example, when a gesture pointing to a place is performed, the controller may judge a target or direction pointed to.

Further, the sensor data may include an image transmitted from any of a plurality of image sensors; and the controller may identify the place shown by the gesture based on an indoor installation place of an image sensor that has transmitted the image and on a result of analyzing the image.

The image sensor may be a camera or a sensor that acquires a distance image. The controller can identify a place shown by a gesture, based on an image.

Further, the first data may be data in which indoor installation places are further associated with the plurality of apparatuses, respectively; and, when detecting the gesture belonging to the first type, the controller may identify the apparatus specified by the user, based on the place shown by the gesture and on the first data.

It is possible to judge which apparatus exists at a place shown by a gesture based on the first data.

Further, the controller may start detection of the gesture belonging to the second type when detecting the gesture belonging to the first type, and start detection of the gesture belonging to the first type when detecting the gesture belonging to the second type.

Further, when detecting a gesture indicating cancellation, the controller may start both of detection of the gesture belonging to the first type and detection of the gesture belonging to the second type.

According to such a configuration, it is possible to start irrespective of order of a gesture of the first type and a gesture of the second type. Further, input can be stopped at any timing.

Further, when detecting the gesture, the controller may generate different feedback for each of types of the detected gestures.

According to such a configuration, it is possible to clearly show whether selection of an apparatus is accepted or input of content of an operation is accepted currently, to the user.

Further, when detecting the gesture belonging to the first type, the controller may generate different feedback for each of the plurality of apparatuses.

According to such a configuration, it is possible to clearly show which apparatus has been selected, to the user.

An embodiment of the present disclosure will be described below based on the drawings. A configuration of the embodiment below is a mere example, and the present disclosure is not limited to the configuration of the embodiment.

### First Embodiment

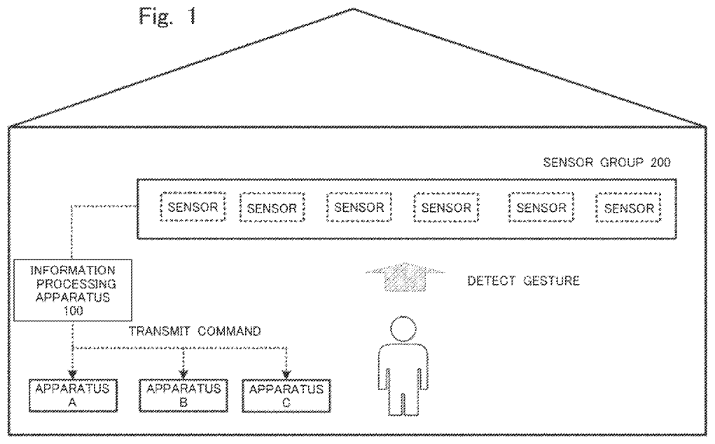

An outline of a control system according to a first embodiment will be described with reference to FIG. 1.

The control system according to the present embodiment is configured including an information processing apparatus 100 associated with a predetermined facility associated with a user (for example, the user's home) and a sensor group 200 including a plurality of sensors that sense the user indoors.

The information processing apparatus 100 is an apparatus that controls a plurality of apparatuses installed indoors (e.g., apparatus A, apparatus B, and apparatus C, as shown in FIG. 1). The information processing apparatus 100 detects gestures performed by the user, using the plurality of sensors installed indoors. Further, based on content of the detected gestures, the information processing apparatus 100 identifies an apparatus, which is an operation target (hereinafter, a target apparatus), specified by the user, and content of an operation for the apparatus, and transmits a control signal to the apparatus.

Though the information processing apparatus 100 is installed indoors in FIG. 1, the installation place of the information processing apparatus 100 may be a remote place. Further, one information processing apparatus 100 may control a plurality of facilities.

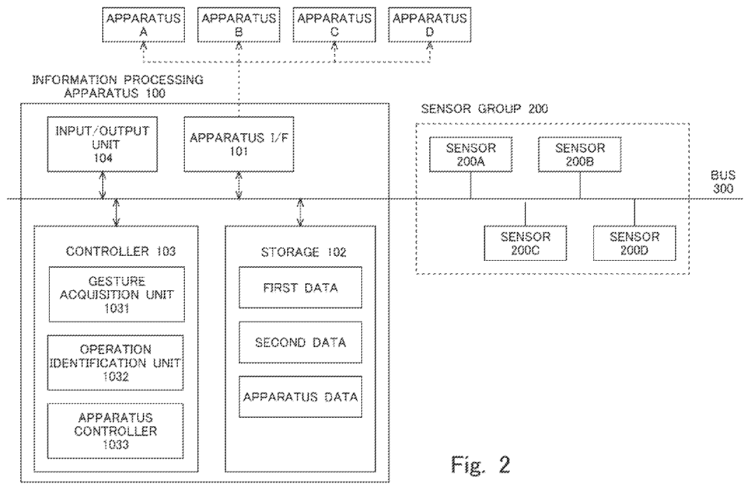

The sensor group 200 includes a plurality of sensors installed indoors (e.g., sensor 200A, sensor 200B, sensor 200C, and sensor 200D, as shown in FIG. 2). The plurality of sensors may be of any kind if they can detect gestures performed by the user. For example, the sensors may be cameras (image sensors) that acquire a visible light image or may be distance image sensors.

Note that, though the user's home is exemplified as a predetermined facility in the present embodiment, a building associated with the information processing apparatus 100 may be an arbitrary facility and is not limited to a home.

FIG. 2 is a diagram illustrating components of the control system according to the present embodiment in more detail. Here, the sensors included in the sensor group 200 and the apparatuses installed indoors will be described first.

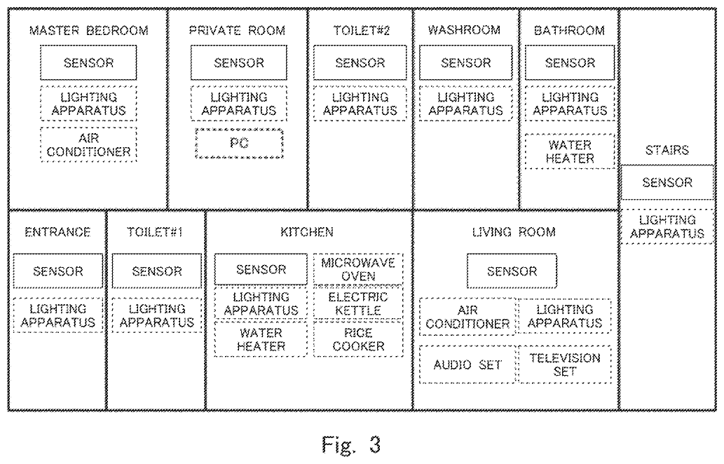

FIG. 3 is a diagram illustrating the plurality of sensors and the apparatuses installed indoors. The plurality of sensors are installed indoors as illustrated by solid lines. Further, the plurality of apparatuses, which are operation targets, are installed as illustrated by broken lines.

The plurality of sensors are configured to be capable of outputting sensor data. If the sensors are image sensors, the sensor data may be image data.

The information processing apparatus 100 is configured to be capable of detecting a first gesture and a second gesture performed by the user. The first gesture is a gesture for specifying an apparatus which is an operation target (a target apparatus). The second gesture is a gesture for specifying content of an operation for the target apparatus.

The information processing apparatus 100 stores data for detecting the first gesture and the second gesture and identifies the target apparatus and the content of an operation, based on a result of comparing the data and sensor data acquired from the sensor group 200.

The information processing apparatus 100 can be configured with a general-purpose computer. In other words, the information processing apparatus 100 can be configured as a computer including a processor such as a CPU and a GPU, a main memory such as a RAM and a ROM, an auxiliary memory such as an EPROM, a hard disk drive, a removable medium and the like. Note that the removable medium may be, for example, a USB memory or a disk storage medium such as a CD and a DVD. The auxiliary memory contains an operating system (OS), various kinds of programs, various kinds of tables and the like. By loading a program contained therein to a work area of the main memory, executing the program and each of components and the like being controlled through the execution of the program, each of functions that meet predetermined purposes as described later can be realized. A part or all of the functions may be realized by a hardware circuit like an ASIC and an FPGA.

An apparatus I/F 101 is an interface for transmitting a control signal to a target apparatus (e.g., apparatus A, apparatus B, apparatus C, or apparatus D, as shown in FIG. 2). The apparatus I/F 101 is configured, for example, including an infrared transmitter or a wireless communication device.

For example, when the apparatus I/F 101 includes an infrared transmitter, it is possible to, by transmitting a predetermined infrared signal, control an apparatus using infrared remote control. When the apparatus I/F 101 includes a wireless communication device, it is possible to, by transmitting a wireless signal in accordance with a communication standard such as Wireless LAN, Bluetooth (registered trademark) or the like, control an apparatus using the communication standard.

A storage 102 is configured including the main memory and the auxiliary memory. The main memory is a memory where a program executed by a controller 103 and data used by the control program are developed. The auxiliary memory is a device in which the program executed by the controller 103 and the data used by the control program are stored.

Furthermore, the storage 102 stores data for recognizing gestures and controlling the apparatuses.

The control system according to the present embodiment detects two kinds of gestures, a gesture specifying a target apparatus and a gesture specifying content of an operation. The former is referred to as a gesture of a first type, and the latter is referred to as a gesture of a second type.

The storage 102 stores data for detecting a gesture of the first type to identify a target apparatus (first data) and data for detecting a gesture of the second type to identify content of an operation (second data). By comparing feature values extracted from sensor data with feature values included in the above data and determining a degree of correspondence, a target apparatus specified by the user and content of an operation can be identified.

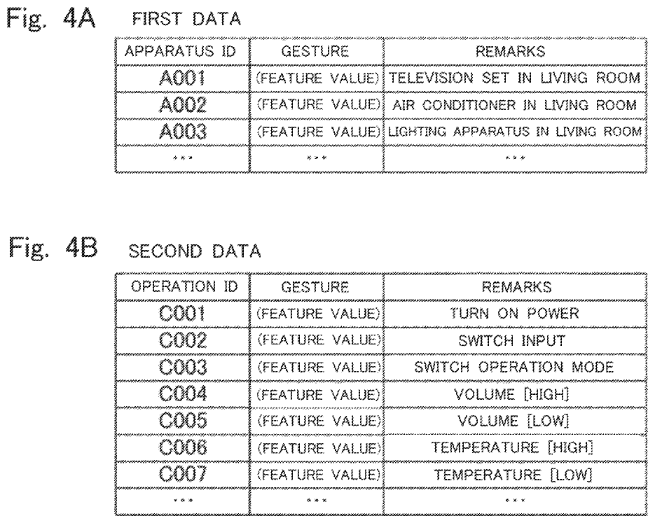

FIG. 4A illustrates an example of the first data. The first data is data in which pieces of data defining gestures of the first type (for example, feature values obtained by converting sensed gestures) are associated with identifiers of the apparatuses (apparatus IDs) .

FIG. 4B illustrates an example of the second data. The second data is data in which pieces of data defining gestures of the second type are associated with identifiers of content of operations (operation IDs).

The data defining the gestures may be generated based on learning results or may be generated beforehand.

As definable gestures, a gesture by a movement, a gesture showing a place, a gesture by a shape of a body part and the like are given.

As the gesture by a movement, for example, a gesture of moving a hand or fingers in a predetermined pattern, a gesture of drawing a figure with a hand or fingers, a gesture of nodding, a gesture of shaking a head and the like are given.

As the gesture showing a place, a gesture of pointing to a predetermined direction with a finger, a gesture of looking in a predetermined direction and the like are given. When the sensors are capable of detecting an orientation of a face or an orientation of a line of sight, a gesture can be performed with an orientation of a face or a line of sight.

As the gesture by a shape of a body part, for example, a gesture of expressing content by a shape of a hand (by the number of raised fingers or the like) is given. For example, definitions of “a gesture of opening a hand indicates affirmation” and “a gesture of closing a hand indicates denial” can be made.

A combination of these can be used. For example, a gesture of “changing an open-hand state to a closed-hand state and moving the hand in that state” and a gesture of “looking in a second direction after looking in a first direction” can be defined.

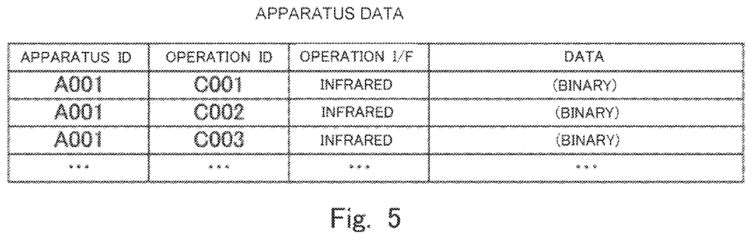

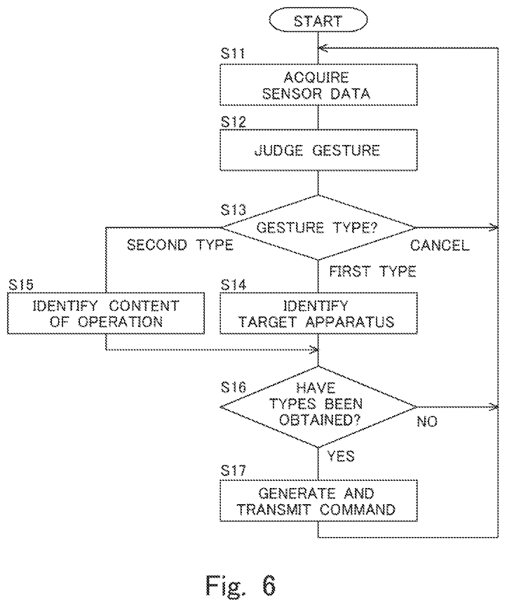

Furthermore, the storage 102 stores apparatus data for defining control signals issued to the apparatuses. FIG. 5 illustrates an example of the apparatus data. The apparatus data is data in which an interface to be used and data to be transmitted are associated with each of combinations of an apparatus ID and an operation ID.

The controller 103 is an arithmetic device that is responsible for control performed by the information processing apparatus 100. The controller 103 can be realized by an arithmetic processing device such as a CPU.

The controller 103 is configured including three function modules of a gesture acquisition unit 1031, an operation identification unit 1032 and an apparatus controller 1033. Each function module may be realized by executing the stored program by the CPU.

The gesture acquisition unit 1031 acquires sensor data from the sensors included in the sensor group 200. The sensor data to be acquired may be visible light image data or may be distance image data. Other formats are also possible.

The gesture acquisition unit 1031 may convert the acquired data to a predetermined format. For example, gestures performed in time series may be converted to a feature value (for example, time-series data showing movement of a feature point), based on image data. In the present embodiment, the gesture acquisition unit 1031 outputs an identifier of a sensor (for example, a sensor installed in a living room) that has captured a gesture and a feature value obtained by converting the gesture.

The operation identification unit 1032 identifies a target apparatus specified by the user and content of an operation based on the data outputted by the gesture acquisition unit 1031, and the first data and second data stored in the storage 102.

Based on the target apparatus and the content of the operation identified by the operation identification unit 1032, the apparatus controller 1033 generates and transmits a control signal for controlling the apparatus. Specifically, the apparatus controller 1033 performs identification of an interface to be used and generation of the control signal based on the apparatus data, and transmits the control signal via the apparatus I/F 101.

An input/output unit 104 is an interface for performing input/output of information. The input/output unit 104 is configured, for example, including a display device or a touch panel. The input/output unit 104 may include a keyboard, near-field communication means, a touch screen and the like. Furthermore, the input/output unit 104 may include means for inputting/outputting a voice. The apparatus I/F 101, the storage 102, the controller 103, the input/output unit 104, and the sensor group 200 may transmit and/or receive data via a bus 300.

Next, a process performed by the controller 103 will be described in more detail.

First, at step S11, the gesture acquisition unit 1031 periodically acquires sensor data transmitted from the sensors belonging to the sensor group 200 and sequentially accumulates the sensor data. The accumulated time-series sensor data is compared with the first data and the second data at an appropriate time to judge whether a gesture matching any predetermined gesture has been performed or not (step S12). For example, when the sensor data is an image, a range from a current frame to a frame a predetermined number of frames before the current frame is converted to a feature value, and degrees of similarity with the predetermined gestures are determined. If a degree of similarity exceeds a threshold, it can be judged that a relevant gesture has been performed.

At step S13, a type of the gesture performed by the user (hereinafter, the inputted gesture) is judged.

Here, if the gesture performed by the user is of the first type, the process transitions to step S14. If the gesture performed by the user is of the second type, the process transitions to step S15.

If the gesture performed by the user is a gesture indicating cancellation (hereinafter, a cancellation gesture), the process returns to step S11. The cancellation gesture is a gesture for stopping input. If the cancellation gesture is performed, the information processing apparatus 100 clears data that has been temporarily stored and returns the state to the initial state. The cancellation gesture can be prescribed beforehand.

At step S14, the operation identification unit 1032 identifies a target apparatus specified by the user based on the inputted gesture and the first data. For example, it is judged that an apparatus with an apparatus ID of A001 (the television set in the living room) has been specified. At this step, it is temporarily stored that identification of the target apparatus has been completed.

At step S15, the operation identification unit 1032 identifies content of an operation specified by the user, based on the inputted gesture and the second data. For example, it is judged that an operation with an operation ID of C001 (turning on power) has been specified. At this step, it is temporarily stored that identification of the content of the operation has been completed.

At step S16, the operation identification unit 1032 judges whether both of identification of a target apparatus and identification of content of an operation have been completed or not. If both of a gesture of the first type and a gesture of the second type are inputted, an affirmative judgment is made at this step. If any of the gestures has not been performed yet, the process returns to step S11.

By repeating the process of steps S11 to S16, the user can perform specification of the target apparatus and specification of the content of the operation irrespective of order of the gestures.

At step S17, the apparatus controller 1033 generates a control signal corresponding to the target apparatus and the content of the operation that have been specified, based on the apparatus data. The generated control signal is transmitted to the relevant apparatus via a specified interface.

As described above, the information processing apparatus 100 according to the first embodiment detects gestures performed by the user by the plurality of sensors installed indoors, and generates and transmits a command for an apparatus. The gestures are classified in a gesture for specifying the apparatus and a gesture for specifying content of an operation, and any of the gestures can be performed first.

According to such a configuration, a gesture assigned to the same operation content (for example, increase/decrease of volume or on/off of power) can be used for a plurality of apparatuses, and it becomes possible to perform a more intuitive operation.

### Second Embodiment

In the first embodiment, a gesture for specifying a target apparatus is defined for each apparatus. However, it is a burden on the user to learn a different gesture for each apparatus. In order to cope with this, a second embodiment is an embodiment in which installation places of the sensors are further utilized to identify a target apparatus.

For example, a case where air conditioners are installed in both of the living room and a private room will be considered. In such a case, specification can be performed by the same gesture for the apparatuses of the same kind (air conditioners).

Here, when a plurality of sensors are installed indoors, it is possible to, for example, by judging “by which sensor installed in which room a gesture has been detected”, presume which apparatus in which room has been specified as an operation target even if the gesture is the same.

For example, when a gesture specifying an air conditioner is performed in the living room, it can be presumed that the air conditioner installed in the living room is the target apparatus. When the same gesture is performed in the private room, it can be presumed that the air conditioner installed in the private room is the target apparatus.

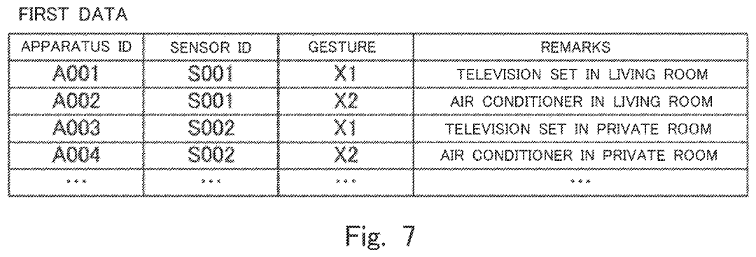

FIG. 7 illustrates an example of the first data used in the second embodiment.

In the second embodiment, identifiers of the sensors are added to the first data. Further, the operation identification unit 1032 acquires an identifier of a sensor that has acquired sensor data at step S13 and further uses the identifier of the sensor to identify a target apparatus.

For example, if a gesture referred to as X2 (indicated by an identifier for convenience) is detected by a sensor with an identifier of S001 (for example, the sensor installed in the living room), the operation identification unit 1032 judges that a gesture specifying the air conditioner in the living room has been performed. If the same gesture X2 is detected by a sensor with an identifier of S002 (for example, a sensor installed in the private room), the operation identification unit 1032 judges that a gesture specifying the air conditioner in the private room has been performed.

Thus, according to the second embodiment, it is possible to assign the same gesture for specifying a target apparatus, to a plurality of apparatuses, and it is possible to improve usability.

### Third Embodiment

In the first and second embodiments, specification of a target apparatus is performed by a gesture that is different for each apparatus. In comparison, a third embodiment is an embodiment in which specification of a target apparatus is performed by a gesture of pointing to a direction of the apparatus.

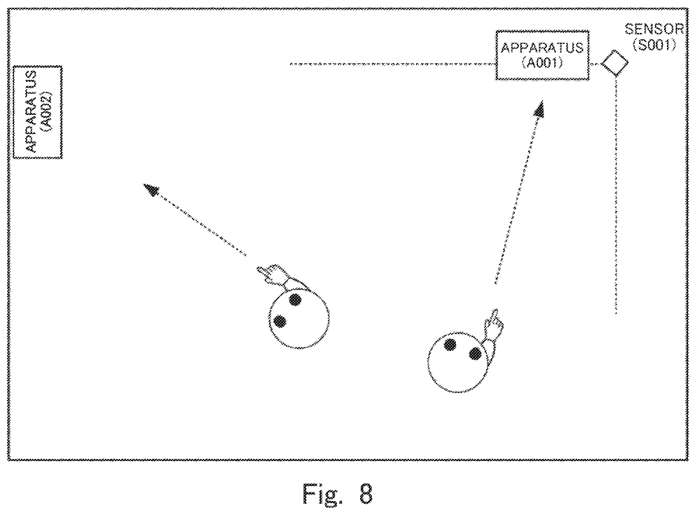

FIG. 8 is a diagram looking down upon the user who is performing a gesture. In FIG. 8, reference sign 5001 indicates an image sensor. As illustrated, when the user performs a gesture of pointing to the apparatus (A001), an image of the user pointing forward is acquired by the sensor (S001). When the user performs a gesture of pointing to an apparatus (A002), an image of the user pointing to the right direction is acquired.

In other words, an apparatus the user is specifying can be identified if (1) a direction that the user points to in an image, (2) an installation position of a sensor indoors and (3) an installation position of the apparatus indoors are known.

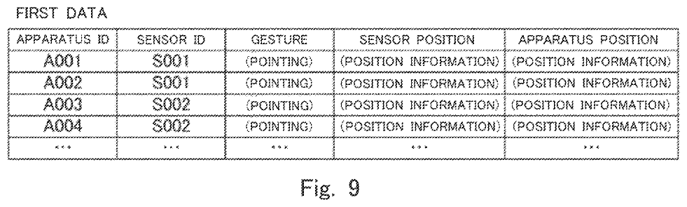

FIG. 9 illustrates an example of the first data used in the third embodiment.

In the third embodiment, all the gestures of the first type show “pointing”. Information indicating the positions of the sensors indoors and information indicating the positions of the apparatuses are stored in the first data.

Further, the operation identification unit 1032 acquires an identifier of a sensor that has acquired sensor data at step S13 and further uses the identifier of the sensor to identify a target apparatus.

Specifically, when detecting a “pointing” gesture, the operation identification unit 1032 narrows down apparatuses based on the identifier of a sensor that has acquired the sensor data. For example, if the gesture has been detected by the sensor with the identifier of S001, apparatuses are narrowed down to the apparatuses with the identifiers of A001 and A002.

Furthermore, the apparatuses are narrowed down based on a direction the user points to and position information about the sensors and the apparatuses included in the first data. For example, in the example of FIG. 8, if a gesture of pointing to the right direction is detected by the sensor with the identifier of S001, it is judged that the apparatus with the identifier of A002 has been specified.

Thus, according to the third embodiment, it becomes possible to perform specification of an apparatus by a gesture of pointing to a particular direction. Thereby, it becomes unnecessary for the user to learn a different gesture for each apparatus, and it is possible to improve usability.

Note that the gesture of pointing to a particular direction does not necessarily have to be performed by pointing with a finger. For example, it is also possible to point to a particular direction by orientation of a face or a line of sight.

(Modification)

The above embodiments are mere examples, and the present disclosure can be appropriately changed and implemented within a range not departing from its spirit.

For example, the processes and means described in the present disclosure can be freely combined and implemented as far as technical contradiction does not occur.

For example, a plurality of kinds of sensors may be combined in order to improve gesture recognition accuracy. For example, a sensor that acquires a voice may be combined, and the process of step S11 may be started when a predetermined keyword is detected.

Further, a gesture of the first type and a gesture of the second type may be continuous. For example, when a gesture of the first type is a gesture of pointing to an apparatus, and a gesture of the second type is a gesture of moving a finger up and down, the gesture of the first type and the gesture of the second type can also be continuously inputted by pointing to an apparatus with a finger and then moving the finger in that state.

Further, when an apparatus recognizes a gesture, feedback may be given to the user. For example, when steps S13 and S14 are executed, a voice may be outputted via the input/output unit 104. As for the voice, in one example, a voice in the case of recognizing a gesture of the first type and a voice in the case of recognizing a gesture of the second type are different. Thereby, the user can recognize a current phase (whether it is a phase of specifying a target apparatus or a phase of specifying content of an operation). Further, when a cancellation gesture is performed, a corresponding voice may be outputted.

Furthermore, when step S13 is executed, a different voice may be outputted according to a selected apparatus. Linking between a voice and an apparatus can be performed, for example, with the first data.

Further, the feedback is not limited to a voice. For example, the feedback can be performed by vibration.

In the description of the embodiments, a gesture is detected at step S11, and a type of the gesture is judged at step S12. However, the type of an input target gesture may be specified. For example, when identification of a target apparatus has been completed, but identification of content of an operation has not been completed, only a gesture of the second type may be detected at step S11. When identification of content of an operation has been completed, but identification of a target apparatus has not been completed, only a gesture of the first type may be detected at step S11.

Though a target apparatus is identified using the first data in the description of the embodiments, identification of a target apparatus may be performed only based on an image. For example, using a camera capable of capturing both of the user and an apparatus, “which apparatus included in an image the user points to” and “what is the apparatus pointed to” may be judged based on a result of analyzing an acquired image.

Furthermore, a process that is described to be performed by one apparatus may be shared and performed by a plurality of apparatuses. Processes described to be performed by different apparatuses may be performed by one apparatus. Which function is to be implemented by which hardware configuration (server configuration) in a computer system may be flexibly changed.

The present disclosure may also be implemented by supplying computer programs for implementing the functions described in the embodiments described above to a computer, and by one or more processors of the computer reading out and executing the programs. Such computer programs may be provided to the computer by a non-transitory computer-readable storage medium that can be connected to a system bus of the computer, or may be provided to the computer through a network. The non-transitory computer-readable storage medium may be any type of disk including magnetic disks (floppy (registered trademark) disks, hard disk drives (HDDs), etc.) and optical disks (CD-ROMs, DVD discs, Blu-ray discs, etc.), and any type of medium suitable for storing electronic instructions, such as read-only memories (ROMs), random access memories (RAMs), EPROMs, EEPROMs, magnetic cards, flash memories, or optical cards.

What is claimed is:

1. An information processing apparatus comprising a controller, the controller being configured to execute:
acquiring sensor data from one or more sensors for detecting gestures performed by a user, the sensors being installed indoors;
detecting a gesture of a first type specifying an apparatus which is an operation target among a plurality of apparatuses and a gesture of a second type specifying an operation to be performed for the apparatus, based on the sensor data; and
executing the specified operation for the specified apparatus when both of the gesture of the first type and the gesture of the second type are detected.

2. The information processing apparatus according to claim 1, further comprising a storage configured to store first data for detecting one or more gestures belonging to the first type and second data for detecting one or more gestures belonging to the second type.

3. The information processing apparatus according to claim 2, wherein
the first data is data in which the one or more gestures belonging to the first type are associated with the plurality of apparatuses, respectively; and
the controller identifies the apparatus specified by the user based on the gesture belonging to the first type.

4. The information processing apparatus according to claim 2, wherein
the first data is data in which combinations of the one or more gestures belonging to the first type and sensors that have detected the gestures are associated with the plurality of apparatuses, respectively; and
the controller identifies the apparatus specified by the user, based on the gesture belonging to the first type and a sensor that has detected the gesture.

5. The information processing apparatus according to claim 3, wherein, when detecting the gesture belonging to the first type, the controller identifies a place shown by the gesture.

6. The information processing apparatus according to claim 5, wherein
the sensor data includes an image transmitted from any of a plurality of image sensors; and
the controller identifies the place shown by the gesture based on an indoor installation place of an image sensor that has transmitted the image and on a result of analyzing the image.

7. The information processing apparatus according to claim 5, wherein
the first data is data in which indoor installation places are further associated with the plurality of apparatuses, respectively; and
when detecting the gesture belonging to the first type, the controller identifies the apparatus specified by the user, based on the place shown by the gesture and on the first data.

8. The information processing apparatus according to claim 1, wherein the controller starts detection of the gesture belonging to the second type when detecting the gesture belonging to the first type, and starts detection of the gesture belonging to the first type when detecting the gesture belonging to the second type.

9. The information processing apparatus according to claim 1, wherein, when detecting the gestures, the controller generates different feedback for each of types of the detected gestures.

10. The information processing apparatus according to claim 9, wherein, when detecting the gesture belonging to the first type, the controller generates different feedback for each of the plurality of apparatuses.

11. An information processing method to be performed by a computer, the information processing method comprising:
acquiring sensor data from one or more sensors for detecting gestures performed by a user, the sensors being installed indoors;
detecting a gesture of a first type specifying an apparatus which is an operation target among a plurality of apparatuses and a gesture of a second type specifying an operation to be performed for the apparatus, based on the sensor data; and
executing the specified operation for the specified apparatus when both of the gesture of the first type and the gesture of the second type are detected.

12. The information processing method according to claim 11, further comprising acquiring first data for detecting one or more gestures belonging to the first type and second data for detecting one or more gestures belonging to the second type.

13. The information processing method according to claim 12, wherein
the first data is data in which the one or more gestures belonging to the first type are associated with the plurality of apparatuses, respectively; and
the apparatus specified by the user is identified based on the gesture belonging to the first type.

14. The information processing method according to claim 12, wherein
the first data is data in which combinations of the one or more gestures belonging to the first type and sensors that have detected the gestures are associated with the plurality of apparatuses, respectively; and
the apparatus specified by the user is identified based on the gesture belonging to the first type and on a sensor that has detected the gesture.

15. The information processing method according to claim 13, wherein, when the gesture belonging to the first type is detected, a place shown by the gesture is identified.

16. The information processing method according to claim 15, wherein
the sensor data includes an image transmitted from any of a plurality of image sensors; and
the place shown by the gesture is identified based on an indoor installation place of an image sensor that has transmitted the image and on a result of analyzing the image.

17. The information processing method according to claim 15, wherein
the first data is data in which indoor installation places are further associated with the plurality of apparatuses, respectively; and
when the gesture belonging to the first type is detected, the apparatus specified by the user is identified based on the place shown by the gesture and on the first data.

18. The information processing method according to claim 11, wherein detection of the gesture belonging to the second type is started when the gesture belonging to the first type is detected, and detection of the gesture belonging to the first type is started when the gesture belonging to the second type is detected.

19. The information processing method according to claim 11, wherein, when the gestures are detected, different feedback is generated for each of types of the detected gestures.

20. A control system comprising:
one or more sensors for detecting gestures performed by a user, the sensors being installed indoors; and
an information processing apparatus configured to execute:
acquiring sensor data from the sensors;
detecting a gesture of a first type specifying an apparatus which is an operation target among a plurality of apparatuses and a gesture of a second type specifying an operation to be performed for the apparatus, based on the sensor data; and
executing the specified operation for the specified apparatus when both of the gesture of the first type and the gesture of the second type are detected.
